(19) United States
(12) Patent Application Publication
(10) Pub. No.: US 2016/0212954 A1
(43) Pub. Date: Jul. 28, 2016

(54) Indoor Hydroponics Systems

(71) Applicant: Onofrio Argento, East Elmhurst, NY (US)

(72) Inventor: Onofrio Argento, East Elmhurst, NY (US)

(21) Appl. No.: 15/004,930

(22) Filed: Jan. 23, 2016

Related U.S. Application Data
(60) Provisional application No. 62/107,939, filed on Jan. 26, 2015.

(51) Int. Cl. A01G 31/06; A01G 7/02; A01G 9/20

(52) U.S. Cl. CPC A01G 31/06; A01G 9/20; A01G 7/02

(57) ABSTRACT

An improved hydroponic apparatus is described. This improved hydroponic system uses renewable energy in containers made from recycled goods. An indoor container controls the weather and all conditions to obtain end results without pesticides or agrochemicals. The system can be fixed or mobile depending on the type of insulation. The system is independent of any kind of weather because it has an internal and external insulation. Indoor temperature also is regulated by a cold-heat exchanger. The lighting system will control the growth and function depending on the program used for each particular crop. The solar panels provide power to all equipment, storing overnight in batteries to keep the system running.

### RELATED APPLICATION

This application claims the benefit of U.S. Provisional Patent Application Ser. No. 62/107,939 filed on Jan. 26, 2015.

### FIELD OF THE DISCLOSURE

The present disclosure relates generally to an improved hydroponics system using renewable energy in containers made from recycled goods. The disclosure also relates to improved systems and methods for growing and marketing hydroponic goods to the general public.

### BACKGROUND

Hydroponics is a growing industry providing food to the world.

Hydroponic gardening is a method of growing plants without soil using only mineral nutrient solutions in water. Hydroponic gardening may be performed either indoors or outdoors. The obvious advantage of outdoor systems is the availability of natural sunlight—the optimal light source for growing. The disadvantages are the evaporative rates of the nutrient solution, accumulation of salt buildup from the fertilizers, and the natural heating of nutrient solution that occurs when exposed outdoors. The last of these disadvantages is the most damaging to the plant. As the solution temperature increases, the roots begin to be impacted and, if the temperature continues to rise, will cause the roots to “rot,” killing the plant. This fact precludes many areas from outdoor hydroponic farming and gardening.

Such an indoor environment may include the use of large industrial containers, many of which remain unused. There may be over 300 million such unused containers in the world causing tremendous damage to the environment. Using these containers for hydroponics may allow for transforming these containers using renewable energy to grow food via hydroponics.

Indeed, the current problem of the quality of the food we eat is directly related to mass production. To meet the needs of a growing population using hydroponics in a container can solve this problem, Various crop cycles with natural nutrients may be grown in climate-controlled environments, all powered by solar panels. The enclosure may be a recycled container which is insulated and which can be transported and is independent of outside climatic conditions.

In addition, other indoor environments can be designed for efficient hydroponic growth. By placing hydroponic in aesthetically pleasing containers, they can be used in the home, in industry and in restaurants to provide the correct conditions for each type of food.

Accordingly, there is a need for improved container designs for the strategic use of hydroponic growth development.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an overhead exterior view of a hydroponic container made from recycled materials.

FIG. 2 is a side interior view of a hydroponic container made from recycled materials.

FIG. 3 is a detailed overhead exterior view of a hydroponic container made from recycled materials.

FIG. 4 is a detailed overhead interior view of a hydroponic container made from recycled materials.

FIG. 5 is a front view of an improved hydroponic exhibition chamber.

FIG. 6 is a schematic view of a home version of a hydroponic grower.

FIG. 7 is a schematic view of a professional version of a hydroponic grower.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. Recycled Container for Hydroponics

The hydroponics system using recycled containers, has as its primary mission the cultivation of various plants and vegetables in a controlled manner without pesticides or agrochemicals. The system operates starting from the seeds in trays, which are irrigated by water sprays through called fogging. The appropriate nutrients are irrigated automatically based on the needs of each of the cultures of seeds and plants. The lighting system is made of a light source for production of photosynthesis. The irrigation water is circulated via the tank where its quality is analyzed to return irrigation circuit. The parameters to be taken into account for this analysis are water hardness, pH and nutrients supply. The materials used in the recycled containers are storage systems consisting of growing trays made of plastic.

This indoor container controls the weather and all conditions to obtain an excellent end result without pesticides or agrochemicals. The system can be fixed or mobile depending on the type of insulation. The system is independent of any kind of weather because it has an internal and external insulation. Indoor temperature also is regulated by a cold-heat exchanger. The lighting system will control the growth and function depend on the program used for each particular crop. The solar panels provide power to all equipment, storing overnight in batteries to keep the system running.

The electrical equipment room and storage is separated by a sliding door to fully isolate the culture room. The irrigation system behaves automatically and is controlled by the computer system and will be adapted to each culture's needs. Display and monitoring system will give us real-time all the parameters corresponding to culture at that time.

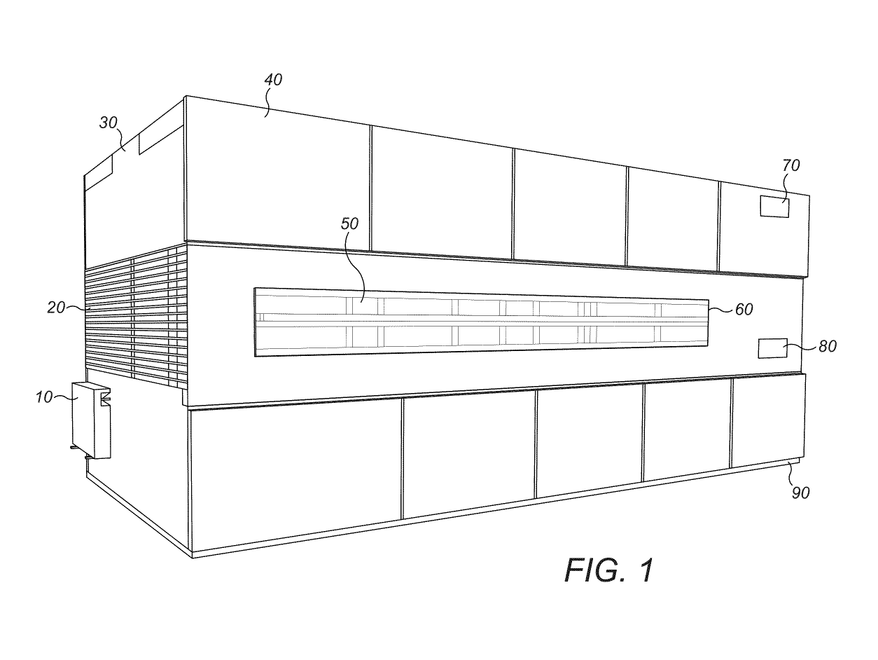

Turning to FIG. 1, shown is an overhead exterior view of a hydroponic container that may be made of recycled components. Included is a 2-sided air conditioner compartment 10, a perforated side panel 20, a ventilation system 30, panels insulated with polyurethane 40, window glass with an air chamber 50, the frame for glass 60, a brand name with LED light 70, an information panel 80 and an aluminum platform 90.

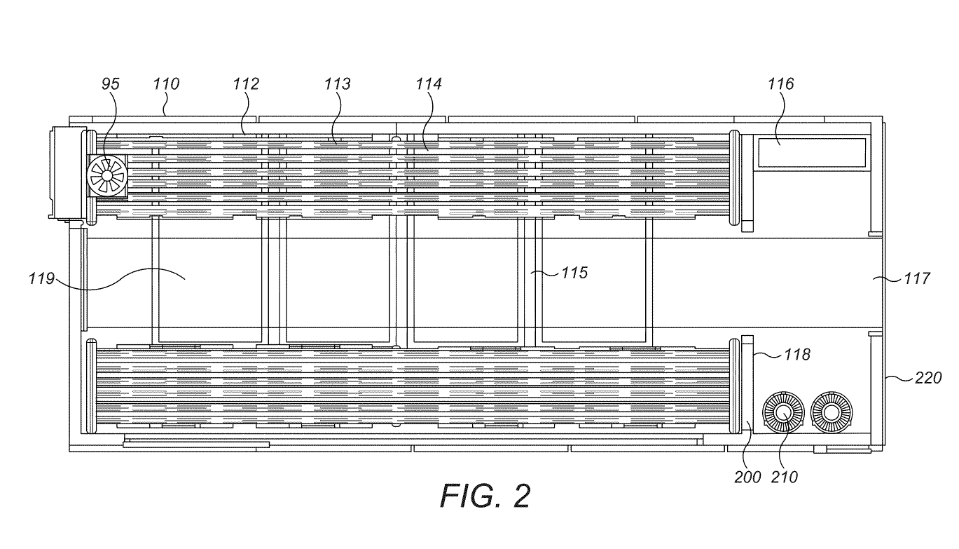

Turning to FIG. 2, shown is a side interior view of a hydroponic container that may made of recycled components. Included is a ventilation roof system 95, the back side panel with polyurethane 110, an interior side panel 112, a wire for the irrigation system 113, a temperature sensor 114, a humidity sensor 115, a basin 116, a sliding door 117, a control system panel 118, an irrigation system 119, an analog-digital convertor 200, water nutrients tanks 210 and a metal exterior door 220.

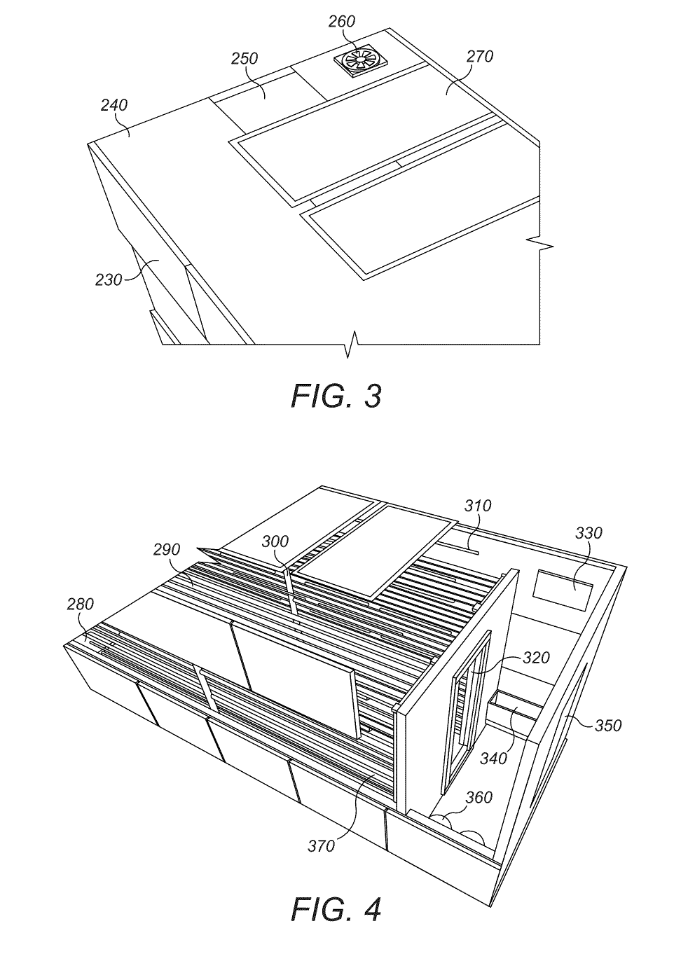

Turning to FIG. 3, shown is a detailed top exterior view of a hydroponic container that may made of recycled components. Shown is a skeleton for mounting panels 230, an insulated roof panel 240, a temperature sensor 250, a roof sensor for air interchange 260 and solar panels 270.

Turning to FIG. 4, shown is a detailed top interior view of a hydroponic container that may made of recycled components. Shown is a support structure 280, irrigation systems 290, LED illumination systems 300, irrigation tube 310, a sliding door sensor 320 an information panel 330, a faucet 340, a frame glass for the door 350, a connector for nutrient and irrigation system 360 and shelves for trays 370.

The foregoing system of growing in containers may be used for all kinds of crops, creating all weather conditions for each. The tanks are then drained of their water and the germinated seeds are placed in predetermined quantities onto trays which are placed at an inlet end of a racking system in the case of sprout or microgreens. In the case of other crops such as tomatoes, strawberries or berries guide lines with brackets may be used instead of trays.

Light walls are provided on opposed sides of the racking system to illuminate the beds. Air cooled by air conditioning is also pushed through via convection to the racking system from the inlet end to the outlet harvest end and the air flow distributes carbon dioxide generated in an inlet end section by the germinating seed grain. Each of the different crops require different conditions of climate, nutrients and water and nutrient needs.

Other features may include:
A disused or recycled container used for irrigation of plants.
A light source for the purpose of photosynthesis,
One or more solar panels for powering the system.
Water spray or fogging process for providing water to the plants.

The basic exterior structure may be a container of 20 feet in good condition. The exterior cover may be green and composed of a panel sandwich. There may be screws hidden in decorative colors (such as aluminum, white and green) on the outside. The interior of the container may consist of a sandwich plate design polyurethane mounted on the walls and ceiling. The panels may be green.

The soil in the container may use a layer of insulation polyurethane under a synthetic parquet white roll. The opening for tray loading may use a window opening to the outside with 2 leaves without glass, coated in the same panel sandwich than the rest of the container. The width may be 2.25 m, the height may be 2.1 m.

The components of the system may include:

1. An air conditioning system of 1800 BTUs.

2. A humidity sensor that may have the following specifications:

| | |
|---|---|
| Humidity | |
| Range of measure | 0 . . . 100% rH |
| Precision | ±2% (in the range 10 . . . 90% rH) |
| | ±3% (other range) |
| Hysteresis | ±1% rH |
| Temperature | |
| Range of measure | −20 . . . +60° C. |
| Precision | ±0.5% measuring range |
| influence (sober on) | ±25%/10° C. |
| Output humidity sensor | |
| Amperage | 4 . . . 20 mA |
| Voltage | 0 . . . 10 V |
| Maximum connectable | ≦100 ohm (power output PCE-P18-2) |
| resistance output | ≦1k ohm (voltage output PCE-P18-3) |
| Data transmission | RS-485 modbus RTU |
| Module of transmission | 8N1, 8N2, 8E1, 8O1 |
| Speed data | 4800 Bit/s 9600 Bit/s 19200 Bit/s 38400 Bit/s |
| | 57600 Bit/s |

A pH Sensor that may have the following features:
Range pH: 0.00-14.00 pH
Resolution: 0.01 pH
Precision: +−0.1

A CO₂ Sensor that may measures levels of carbon dioxide in the range from 0 to 100,000 ppm. This is very useful for measuring levels to determine photosynthesis.

A Controlador PLC may be used with the following features:

| | |
|---|---|
| Screen | |
| Technology | Graphic LCD TFT |
| Colors | 65,536 colors |
| Dimensions | 7″ |
| Resolution | 800 × 480 pixel |
| Backlight | LED Bianco |
| Duration (min. at 25° C.) | 50,000 hours |
| Touch screen | Analog |
| Terminal | |
| Processor | Intel PXA270 (r) |
| CPU clock | 64 MB |
| RAM | 520 MHz |
| Flash | 32 MB |
| Interface | |
| First port | SP1 (RS232/485/MPI) |
| Second port | SP2 (RS232/485/MPI), CAN, Profibus-DP |
| Network | Ethernet 10/100 Mbit - Rj45 |
| USB Host port | USB 1.1 |
| Port USB Device | USB 1.1 |
| Slot Cardbus | Secure Digital/MMC |
| Audio | not applicable |
| Dimensions | |
| External (L/A/P) | 228 × 155 × 44.3 (mm) (63.7 with dual port) |
| Perforated (l/) | 219 × 146 (mm) |
| Technical data | |
| Power | 18 . . . 32 Vdc |
| Absorbed power | ~8 W (at 24 Vdc) |
| Operating temperature | 0 . . . +50° C. |
| Temperature storage | −20 . . . +65° C. |
| Moisture | <90% (non-condensing) |
| Hardware clock | Super-condenser 72 h |
| Weight | ~2.6 kg |
| Degree of protection | IP69K front (in progress) |
| Certifications | CE, ATEX Zone II cat. 3 G, Vibration, |
| | EN60068-2-6 Shock EN60068-2-27, Humidity |
| | EN60068-2-30 |
| Programming software | Polymath HMI/Polymath Advanced |

The lighting system may include LED tubes or strips of grow-type LEDs with the following features:

| | |
|---|---|
| Input voltage | AC85~264 V |
| Lux | 0.5M/706, 1M/185, 1.5M/85 |
| Working current | 300 mA |
| Useful life | 50,000 Hours |
| Working frequency | 50/60 Hz |
| Color | Red/blue/other |
| Working temperature | −20°-40° |
| Area of illumination | 0.7 m2 |

The shelves may be PVC and may consist of 3 Rows of tray per floor, with a total of 8 shelves. The overall dimensions may be 0.6 meters wide by 2 meters maximum. The trays may be 0.6 meters by 0.6 meters in rigid plastic or thermoforms.

The water tank may be 1000 liters.

The system may be controlled by a programmable logic controller (PLC) programmer type. This is responsible for controlling all the processes needed to manage nutrients, lights turn on and off, control PH, air quality, temperature and irrigation system. A PLC or programmable controller is a digital computer used for automation of typically industrial electromechanical processes, such as control of machinery on factory assembly lines, amusement rides, or light fixtures. PLCs are used in many machines, in many industries. PLCs are designed for multiple arrangements of digital and analog inputs and outputs, extended temperature ranges, immunity to electrical noise, and resistance to vibration and impact. Programs to control machine operation are typically stored in battery-backed-up or non-volatile memory. A PLC is an example of a “hard” real-time system since output results must be produced in response to input conditions within a limited time, otherwise unintended operation will result.

The monitoring and adjusting the hydroponic container may involve the following processes:

1. A startup test to determine that all products are operational.

2. A choice of processes to establish hydroponic protocols for microgreens, sprouts or a combination thereof

3. Beginning hydroponic processes when tray of microgreens or other plants is loaded into the container. Based on the type of plant, the temperature, irrigation, humidity control and set for a pre-determined number of days. The process ends upon removal of the trays. During the process, data is gathered (plant temperature, environment temperature, humidity, water level and the like) and appropriate adjustments are made. Such adjustments may include changing humidity, changing water level, changing nutrients, changing the fan speed and the like).

The combination of all these processes will result in proper control for all types of crops. The water manifold described herein equalizes pressure for all bucket feed lines, providing uniform water flow and nutrient delivery, independent of the number of stations between the source and furthest grow bucket from the pump. This method may render the serial delivery methods of other systems unnecessary.

### II. Hydroponic Indoor Display Device

An indoor display device can be used as a form of marketing to display and market sprouts, microgreens and herbs. The design of this equipment relies on a display with various samples shown in an appealing manner. A PLC incorporating micro-control foggers to maintain a constant humidity in the plants is used.

Microgreens in the device are small edible greens produced from the same seeds that are used for full sized vegetables, herbs or other plants that are harvested before they fully develop. Commonly grown varieties of microgreens are amaranth, arugula, beets, basil, cabbage, celery, chard, chervil, cilantro, fennel, kale, mustard, parsley, radish, and sorrel. Microgreens usually have intense flavors considering their small size.

Sprouts are simply germinated seeds but in this case what is eaten consists of the seed, root, stem and pale, underdeveloped leaves. Commonly grown varieties of sprouts are alfalfa, sunflower, cress, lentil, and buckwheat. Sprouts are produced in water and the seeds are placed with high density in the sprouting equipment or enclosed container. The sprouting process is done in high moisture and low light conditions. The seeds are usually soaked for one day and then rinsed in water several times a day for a few days until they are ready. Most sprouts are usually harvested in 3 to 5 days, much faster than most microgreens

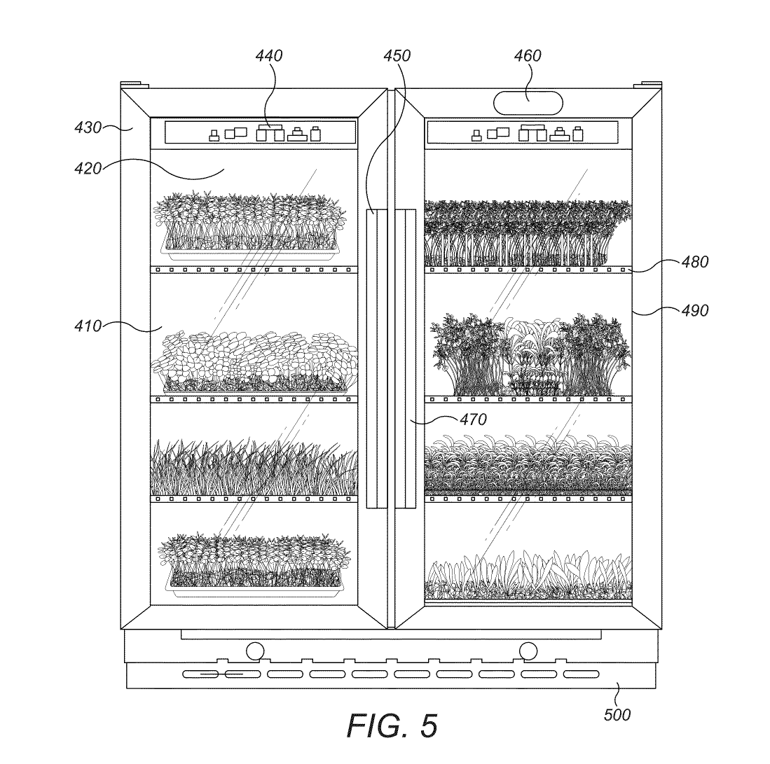

Turning to FIG. 5, shown is the display device with door glass 410, a humidity fogger 420, a metal frame door 430, a display panel 440, a door front close 450, a brand name with LED light 460, an aperture sensor 470, shelves for trays 480, a climate sensor 490 and an aluminum platform 500. The devices is appropriate for growing sprouts and microgreens.

This device may be used as a marketing system for microgreens, sprouts and aromatic herbs that maintains the temperature and humidity in a display. The device may be used for restaurants to display microgreens, sprouts and herbs grown recently to offer their customers. This gives the possibility of chefs offer such fresh cultures that are freshly cut in front of customers.

The loading, monitoring and maintenance of the device may be similar to the recycled material hydroponic container with changes made to account for its smaller size.

### III. Indoor Hydroponic System Layouts

The indoor hydroponic system layouts that may be used in the foregoing embodiments are set in further detail below. Specifically, the hydroponic system may be used as a home-based model or a professional-based model. Each relies on the use of sensors, adjustments and recycled power to make the hydroponics system efficient and ecological.

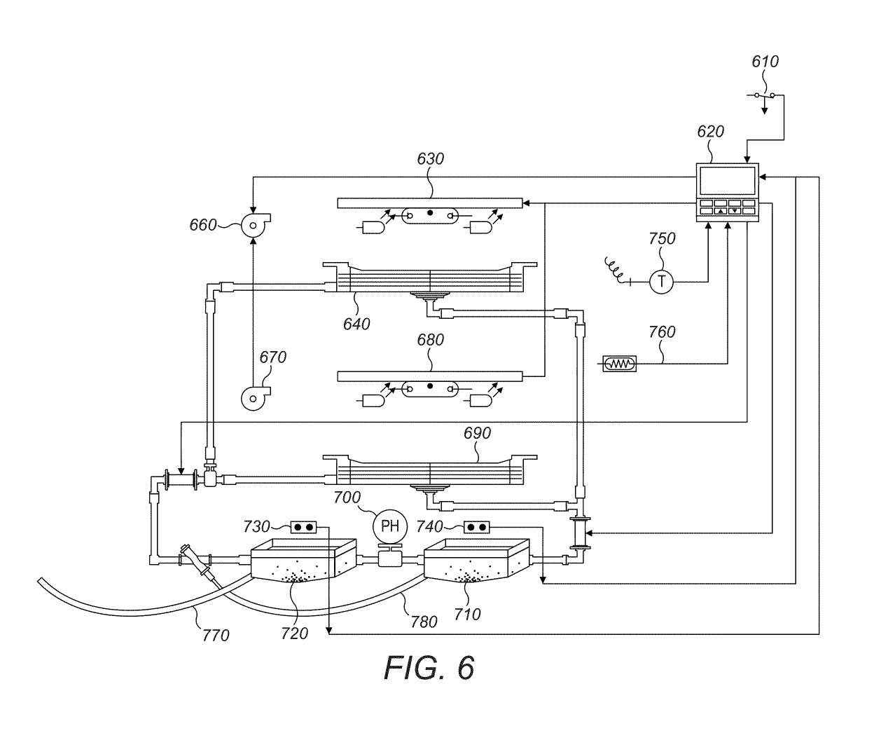

Turning to FIG. 6, shown is an example of a home-based hydroponics model with two growing trays and two water basins. Shown is line power 610 that powers the PLC 620. Connected to the PLC 620 is the humidity sensor 760 and temperature sensor 750. The PLC monitors controls a plurality of fans 660, 670 to provide climate control. The PLC controls a plurality of LED displays 630, 680 showing data related to the hydroponic system. The PLC monitors and controls the plurality of level sensors 730, 740, each monitoring the plurality of basins 710. 720. The basins 710, 720 are fed with water from pipes 770, 780 and are monitored by a pH monitor 700. The water is also piped to a plurality of growing trays 640, 690.

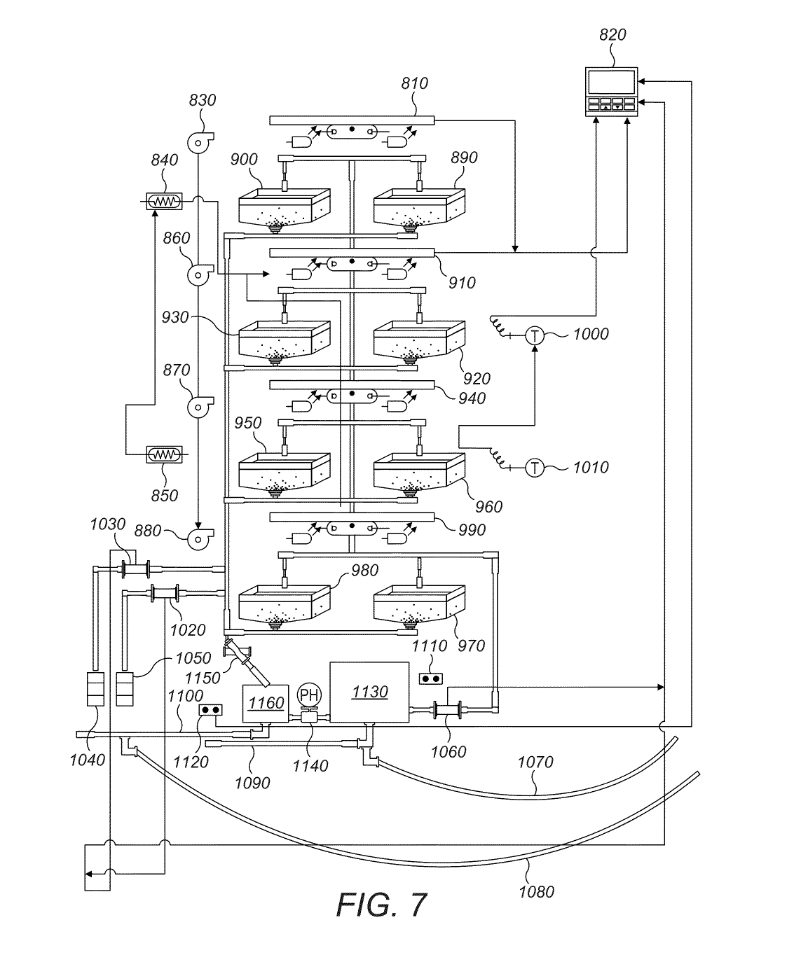

Turning to FIG. 7, shown is an example a professional-based hydroponics model with eight growing trays 890, 900, 920, 930, 950, 960, 980, 970 in 4 levels. Each level is cooled by a plurality of fans 830, 860, 870, 880. Each level has an associated LED display 810, 910, 940, 990. Every two levels have a humidity sensor 840, 850 and a temperature sensor 1000, 1010.

The PLC 820 controls and monitors a pump 1060, which is connected to a large water tank 1130. The large water tank 1130 is connected to a small water 1160 tank via a pH monitor 1140. The large water tank 1130 has a level sensor 1110 and the small water tank 1160 has a level sensor 1120. A plurality of pH monitors 1040, 1050 is connected to a plurality of pumps 1030, 1020 the feed the water pumping system to keep the pH at a desired level. A filter 1150 is connected to the small water tank 1160 for filtering the water prior to being circulated to the rest of the system.

To add water to the system, the water supply connection 1090 leads to the water supply (such as a municipal water supply) to feed water to the large water tank 1130. Alternatively, the large water tank 1130 may be supplied with water via a water manual refill 1070. To drain water from the system, the water drain connection 1100 leads to a water drain (such as a municipal water drain) to draw water from the small water tank 1160. Alternatively, the small water tank 1160 may be drained via a water manual drain 1080.

### IV. Conclusion

The various features of the foregoing embodiments may be selected and combined to produce numerous variations of improved indoor hydroponic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An hydroponic apparatus comprising:
a container having a support structure, an irrigation system, an irrigation tube, a sliding door sensor, an information panel, a faucet, a connector for nutrient and irrigation system, and a plurality of tray shelves;
germinated seeds placed in the plurality of tray shelves;
light walls opposed sides illuminate the germinated seeds; and
an air cooling system for circulating cooled air throughout the container

2. The apparatus as in claim 1 wherein the cooled air pushed through via convection to the tray shelves to distribute carbon dioxide

3. The apparatus as in claim 1 wherein the light walls comprise an LED illumination system.

4. The apparatus as in claim 1, further comprising a plurality of solar cells to provide power to the container.

5. The apparatus as in claim 4, further comprising a water spray system to provide water to the germinated seeds.

6. The apparatus as in claim 5 wherein the container also has an exterior that is comprised of recycled material.

7. The apparatus as in claim 6, further comprising a pH sensor.

8. The apparatus as in claim 6, further comprising a CO₂ sensor.

9. The apparatus as in claim 6, further comprising a CO₂ sensor.

10. The apparatus as in claim 6, further comprising a programmed logic controller.

11. An indoor hydroponic display device comprising:
a chamber having a front glass door, a humidity fogger, a metal frame surrounding the front glass door, a display panel, an aperture sensor, a plurality of shelves for trays designed to contain plants, a climate sensor, and an aluminum platform;
a programmed logic controller incorporating micro-control foggers to maintain a constant humidity in the chamber.

12. The apparatus as in claim 11, further comprising a plurality of hydroponic plants placed in the plurality of trays.

13. The apparatus as in claim 12, further comprising a plurality of solar cells to provide power to the device.

14. The apparatus as in claim 12, further comprising a temperature control, an irrigation control and a humidity control.

15. The apparatus as in claim 14 wherein the temperature control, the irrigation control and the humidity control are set for a pre-determined number of days depending on the nature of the plurality of hydroponic plants.

16. A hydroponics growing system comprising:
a plurality of growing trays, each of the plurality of growing trays including hydroponic plants;
a plurality of fans;
a plurality of displays;
a plurality of humidity sensors;
a plurality of temperature sensors;
a plurality of water tanks;
a pump connected to the plurality of water tanks;
a programmed logic controller for controlling the pump, fans, displays, humidity sensors, temperature sensors and water tanks.

17. The system as in claim 16, wherein the plurality of water tanks include a small water tank and a large water tank;
and further comprising a first pH monitor connected between the small water tank and the large water tank.

18. The system as in claim 17, further comprising a plurality of second pH monitors connected to a plurality of pumps that provide water to the plurality of growing trays.

19. The system as in claim 18 further comprising a filter connected to the small water tank for filtering the water prior to being circulated to the rest of the system.

20. The system as in claim 19 further comprising a water supply connector interfacing between a water supply and large water tank and a water drain connector interfacing between a drain and the small water tank.
